(19) United States
(12) Patent Application Publication
(10) Pub. No.: US 2026/0135483 A1
(43) Pub. Date: May 14, 2026

(54) FAST TRANSIENT FEED FORWARD RESPONSE FOR AN INTEGRATED CIRCUIT

(71) Applicant: MaxLinear, Inc., Carlsbad, CA (US)

(72) Inventors: Glenn Chance Dunlap, III, Houston, TX (US); Rajat Channappanavar, Bengaluru (IN)

(73) Assignee: MaxLinear, Inc., Carlsbad, CA (US)

(21) Appl. No.: 19/383,446

(22) Filed: Nov. 7, 2025

Related U.S. Application Data
(60) Provisional application No. 63/718,542, filed on Nov. 8, 2024.

(51) Int. Cl. H02M 3/156

(52) U.S. Cl. CPC H02M 3/156

(57) ABSTRACT

A system and method for multiphase or single-phase power control is disclosed herein. The system may include a hysteretic window generator. The hysteretic window generator may dynamically set and modulate a lower voltage threshold and an upper voltage threshold for phases of the multiphase power control based on an operating condition. Switching power supply (SPS) stages may correspond to the multiple phases. The SPS stages may be coupled to the hysteretic window generator. A fast transient addition may be coupled to the hysteretic window generator and activated by a transient load condition of one of the plurality of SPS stages. The fast transient addition may output a non-linear step adjustment to a control voltage of one of the plurality of SPS, thereby reducing a settling time and return to a predefined voltage level.

### RELATED APPLICATION

This application claims the benefit of U.S. Provisional Application No. 63/718,542, filed November 8, 2024, the disclosure of which is incorporated herein by reference in its entirety for all purposes.

The examples discussed in the present disclosure are related to fast transient feed forward response for an integrated circuit.

### BACKGROUND

Unless otherwise indicated herein, the materials described herein are not prior art to the claims in the present application and are not admitted to be prior art by inclusion in this section.

The field of power electronics has seen considerable advancements with the advent of digital control in power supply units. Digital control in switching power supplies has evolved to allow for management of single or multiple phases in power conversion processes. Such multiphase and single phase digital controllers synchronize several power stages to efficiently handle high-current demands while reducing thermal stress and electromagnetic interference. This synchronization enables the power supply to deliver a stable and low-ripple output voltage, which may be advantageous for the reliable operation of sensitive electronic devices and systems. However, many digital switching regulators and controllers lack real-time control with current balancing across the multiple phases. Such power electronics include control techniques for managing the demands of modern electrical systems yet often struggle with fast transient events.

Transient events, over time, cause voltage sags, overshoots, and prolonged settling times, which may adversely affect the performance and reliability of connected electronic devices.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

Some examples include a system for multiphase or single phase power control. In some examples, the system may include a hysteretic window generator to dynamically set and modulate a lower voltage threshold and an upper voltage threshold for an individual phase within phases. Switching power supply (SPS) stages may correspond to the phases, and may be coupled to the hysteretic window generator. A fast transient addition may be coupled to the hysteretic window generator, and activated by a transient load condition of an individual output. The fast transient response may output a non-linear step adjustment to a control voltage of one of the SPS, thereby reducing settling time.

A method for optimizing transient response in a multiphase or single-phase power control system having a plurality of SPS stages may be provided. The method may include determining a trigger level based on one or more control settings, in which the trigger level activates a fast transient response. The method may include determining a charge deficit associated with the transient load condition based on an output voltage change and an output capacitance of the multiphase power control system. The method may include adjusting, based on the charge deficit, the control voltage of one of a singular or plurality of SPS stages using the fast transient response, thereby counteracting the transient load condition and stabilizing the power control system output voltage.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIG. 1 illustrates a schematic of an exemplary switching power supply system;

FIG. 2 illustrates schematic of an exemplary control loop circuit for use in the system shown in FIG. 1;

FIG. 3 illustrates schematics of an exemplary controller;

FIG. 4A-4C illustrates timing diagrams depicting exemplary operations of an exemplary switching power supply system; and

FIG. 5 illustrates a graphic user interface corresponding to an exemplary switching power supply system.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more examples herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The examples described herein relate generally to an advanced digital quad controller (hereinafter “the controller”) that significantly enhances management in a single or multiphase power supply system. The controller may include a multiphase control loop, which may provide superior performance and efficiency in regulating and distributing electrical power. As described in detail below, the controller may intelligently orchestrate activity across multiple power phases to ensure synchronized load sharing and minimize power loss. Such synchronization may be advantageous for reducing ripple and improving the overall stability of the power supply. Some examples include a fast transient response, load feed forward operation for effectively reacting to transient load conditions. The fast transient response may provide a voltage adjustment during the transient load condition.

Leveraging an intelligent control architecture that includes a fast pulse response tuning feature, the controller of the examples herein may swiftly compensate for fluctuations in output voltage caused by sudden load variations, without compromising on noise or stability. Such tuning may be facilitated by a calculated one-shot command that may temporarily alter the control voltage in a non-linear fashion, effectively bringing the output voltage to a desired state in an accelerated timeframe. The flexibility provided by the examples herein, including user-configurable parameters such as dampening percentage, trigger level, and maximum allowable current, may provide users with the tools to fine-tune power supplies to a remarkable degree of precision. Such advancements underscore the controller’s adaptability to a wide range of applications, positioning it as a groundbreaking solution in the field of power supply design.

The fast-transient response according to one or more examples described below, may improve the controllers capacity to address sudden phase changes, ensuring robust operation and voltage stability. Fast transient load feed forward operations as described herein may be advantageous for applications where performance and reliability are used such as communication, robotics, and semiconductor technology. The fast-transient, load feedforward capability represents a significant advancement in the design and functionality of system 100.

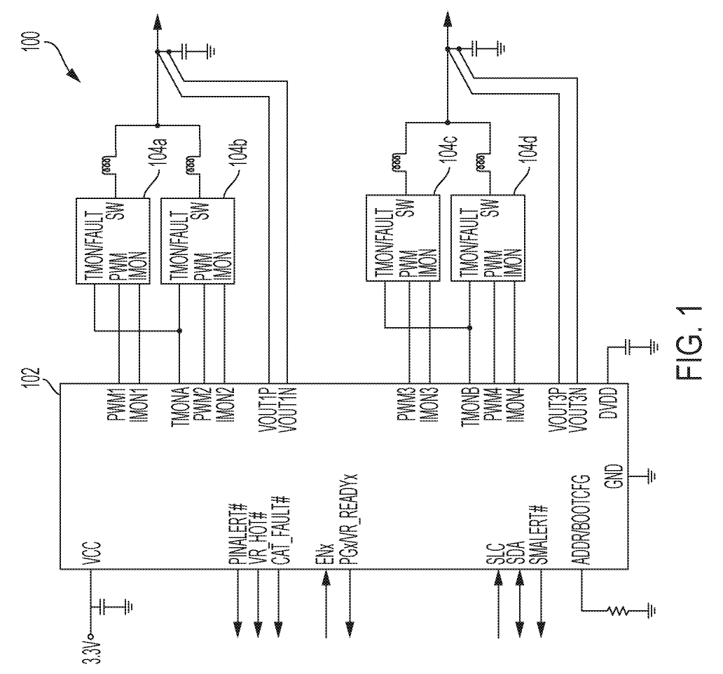

FIG. 1 illustrates a schematic of a Switching Power Supply System 100 (hereinafter “system 100”). System 100 may include Multi-Phase Digital Quad Controller 102 (hereinafter “controller 102”), and Switching Power Stage (SPS) 120. Controller 102 may encompass a communication architecture that may advantageously maximize efficiency and power distribution by performance with four Switched Power Stages (e.g., SPS 120) within system 100. As shown in FIG. 1, system 100, via controller 102, may be configured to efficiently manage and drive up to four outputs simultaneously via SPS 120a, 120b, 120c, 120d, (collectively “SPS 120”). Accordingly, controller 102 may perform logic operations, decision-making, and overall system management, while SPS 120 may encompass individual power conversion units, which controller 102 manages. Such SPS 102a, 102b, 102C, 102d may herein interchangeably be referred to as "phases" in a multiphase power supply system (e.g., 100). All, or some of, the 4 SPS stages may have different Vin voltages. System 100 may correspond to single phase operation in which SPS 102a, 102b, 102c, 102d may correlate to separate channels (i.e. outputs) for such single phase operation of system 100.

Advantageously, controller 102 may include a design focusing on minimal hardware, reducing setup complexity and time. For example, controller 102 may achieve such minimal hardware, by utilizing resistor for address and configuration settings (ADDR/BOOTCFG), streamlining the hardware setup process. ADDR/BOOTCFG not only minimizes the component count but also facilitates a more compact and cost-effective design.

Operational parameters may be governed via software, offering a versatile and user-friendly interface for configuration. Controller 102 software suite may include a graphical user interface (GUI) (not shown), which may allow for effortless setup and fine-tuning of the device. Such GUI allows users to adjust settings, monitor performance, and tailor the controller to specific application without hardware modifications.

System 100 via controller 102 and SPS 120 may be used for control and adjustability, offering precision in power regulation. Such software-driven approach provides the flexibility to adapt to a wide array of operational conditions, ensuring that controller 102 delivers optimal performance across various scenarios. With such level of control, users may expect a responsive system capable of meeting the demands of sophisticated power systems.

As shown in FIG. 1, controller 102 may include various input pins, output pins and/or input/output (I/O) pins. For example, in some examples, controller 102 may include voltage common collector (VCC) pin. Vcc pin may be the main power supply input to controller 102, providing the power for the internal circuits and logic of controller 102.

Enable (ENx), power good (PGx), and voltage regulation ready (VR_READYx) pins may enable inputs for the power stages and power good outputs indicating when phases may be ready or within regulation. SV_CLK, SV_DATA, SV_ALERT# pins may provide a serial interface for communication with the controller. For example, for software based configuration, monitoring, and/or alerting purposes. SCL / SDA / SMALERT# pins may correspond to an inter-integrated circuit (I2C) bus interface, and/or other communication protocols for ICs (e.g., power management bus (PMBus) interface). For example, SCL may be the clock line, SDA may encompass the data line, and SMALERT# may encompass an alert signal.

Utilizing a single resistor to set the address or configuration may simplify the hardware design. For example, instead of multiple jumpers or switches, one component may be used, which may minimize space on the printed circuit board (PCB) and reduce manufacturing complexity. Moreover, in a multi-device system where several devices of the same kind may be present on the same bus, each device may use a unique address. The single resistor selection may allow for easy hardware-based address assignment by changing the resistance value, which may be read by the device at startup and correspond to a specific address. Similarly, when the resistor is used for configuration, changing the value may alter operational parameters of the device without reprogramming or using additional hardware.

SPS 120a-120d may include pins and interconnections for communicating with controller 102. Such communication interfaces may include, but are not limited to, pins shown as temperature monitoring and fault detection (TMON/FAULT), pulse width modulation (PWM), current monitoring (IMON), and/or switch (SW). The TMON/FAULT pin may be purposed for temperature monitoring and fault detection, enabling proactive system protection. The PWM pin may correspond to the pulse width modulation signals for controlling the power stages. The IMON pin may provide real-time current monitoring feedback, advantageous for the regulation of power delivery. And the SW pin may serve as a switch node, a junction in the power conversion process. Together, SPS 120 pins may form an integrated network facilitating efficient signal transmission and system regulation.

For example, PWM1, PWM2 outputs from controller 102 to SPS 104a, 104b may determine the pulse width modulation signals, controlling the timing and duration of the power transistors' switching events within SPS 104a, 104b. IMON1, IMON2 correspond to current monitoring. IMON1, IMON2 outputs may represent the monitored current flowing through the respective SPS 104a, 104b. IMON1, IMON2 outputs may be utilized for feedback in a control loop (not shown) to regulate the current or for protection purposes.

Controller 102 includes temperature monitoring A (TMONA), which may provide temperature monitoring. As shown in FIG. 1, TMONA may be a shared terminal and used for temperature monitoring across multiple SPS 104a, 104b. TMONA may collect temperature data to ensure that system 100 operates within under or substantially under a temperature threshold corresponding to safe thermal conditions. For example, TMONA circuitry may trigger a fault condition when an over-temperature event is detected.

Controller 102 includes pins voltage output positive (VOUT1P), voltage output negative (VOUT1N). Voltage output pins may be the positive and negative terminals of the output voltage from SPS 104a, 104b. VOUT1P, VOUT1N pins provide the regulated voltage output that system 100 provides. For example, PWM signals may be advantageous for controlling the switching power devices in SPS 104, which may convert the DC input to a regulated output with the desired voltage and current characteristics. The IMON signals (e.g., IMON1, IMON2, IMON 3, and/or IMON4) may be advantageous for ensuring that the amount of current flowing through SPS 120 may be within the system 100 specifications and for making dynamic adjustments based on changing loads.

As shown in FIG. 1, the sharing of the TMONA signal between different phases (e.g., SPS 104a, 104b) may offer an integrated temperature monitoring system that simplifies the thermal management by reducing the number of sensors used, thereby streamlining the hardware design with minimal components. The VOUT1P and VOUT1N may represent a differential pair, facilitating system 100’s ability to minimize noise and ensure accurate voltage delivery, which may be advantageous in high-precision applications or in environments with significant electrical interference.

As shown by pins PWM3 and PWM4, system 100 may include a modular, symmetrical protocol in the design of controller 102 that drives four outputs (i.e., SPS 104a, 104b, 104c, 104d). Such modular, symmetrical protocol, along with the shared architecture for other phases, may facilitate a uniform and modular approach to power management. Such dual or mirrored approach in the design of system 100 components (e.g., 102, 120) may be advantageous for a variety of reasons. PWMs may be grouped. For example, as shown system 100 may include 4 outputs and 4 PWMs. Some phases may be grouped or tied together (wherein SPS is controlled by PWM) to a single output in order to have multiphase.

For example, the symmetrical design allows that each phase, represented by PWM1/IMON1 through PWM4/IMON4, may follow the same or substantially the same architectural framework. Such modular configuration may facilitate scalability since additional phases may be added following the same architectural framework, which simplifies processes and ensures consistency for SPS 104 output. Moreover, modularity also aids in manufacturing and troubleshooting, as the same, or substantially the same, components and design considerations apply to each SPS 104.

When system 100 corresponds to multiphase operations, employing such mirrored architecture across switching power supplies may ensure that individual phases behave similarly, leading to similar performance when driving multiple outputs. Similar performance may be particularly advantageous in applications where accurate load balancing across phases is used. Phase alignment may be executed by adjusting voltage thresholds according to phase load balancing. The mirrored configuration for the control of individual phases ensures that the performance characteristics, such as efficiency, response time, and thermal management, may be uniform across the board, reducing the complexity of system-level optimization. Thus, phases of SPS may be configured to handle failure via symmetry. The symmetry in the design may provide redundancy. If one phase were to fail, the other phases, being identical, may share the increased load, enhancing system 100’s overall reliability. For example, in critical applications where downtime is not permitted, such redundant design approach may ensure continuous operation, with the remaining phases compensating for the one that is out of service.

While the PWM signals may control the timing and duty cycle for power delivery in each phase, the IMON signals may provide a feedback mechanism for current monitoring. Such feedback monitoring may be advantageous for closed-loop control and protection. The mirrored design provides that similar feedback control algorithms may be applied across phases, streamlining the development of control firmware and software. Moreover, as shown in FIG. 1, temperature monitor TMONA, TMONB may have a shared connection to multiple phases, reflecting an integrated approach to temperature management across the controller system. The single-point monitoring simplifies the thermal management of the system, as the same cooling strategy may be applied uniformly.

SW pins may represent a switch node, for example, in a buck converter topology, which may be points where the high-frequency switching occurs. Having a symmetrical design for the SW pins across phases may provide that the parasitic elements and switching characteristics are uniform, which may simplify the layout considerations for electromagnetic compatibility and efficiency. Such switch node design may also mean that the ripple current and voltage may be easily managed and filtered, as the inductors and capacitors in the output filters may be identical, conserving the cost and space.

Controller 102 may uniformly manage all phases due to the symmetry discussed above. Uniform management may allow for a streamlined software and hardware interface, as the control algorithms may not be individually tailored for each, or individual, phase(s). Such uniformity may allow for a more intuitive and user-friendly GUI for device setup, as the settings for one phase may be applicable to the others. Doing so may reduce the complexity of system configuration and maintenance. Thus, the dual approach in the design of system 100 may provide a steady and efficient method for managing multiple power stages in a power supply system. The uniformity and symmetry of the phases provide that the system may be optimized for performance, ease of use, and reliability, all of which may be highly advantageous in modern electronic applications.

Controller 102 and/or SPS 104 may include a number of processing units and/or CPUs. Use in any application involving processors and/or software: One or more aspects or features of the subject matter described herein may be realized in digital electronic circuitry, integrated circuitry, specially designed application specific integrated circuits (ASICs), field programmable gate arrays (FPGAs) computer hardware, state machines, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers.

These computer programs, which can also be referred to programs, software, software applications, applications, components, or code, include machine instructions for a programmable processor, and may be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide non-transitory machine readable instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

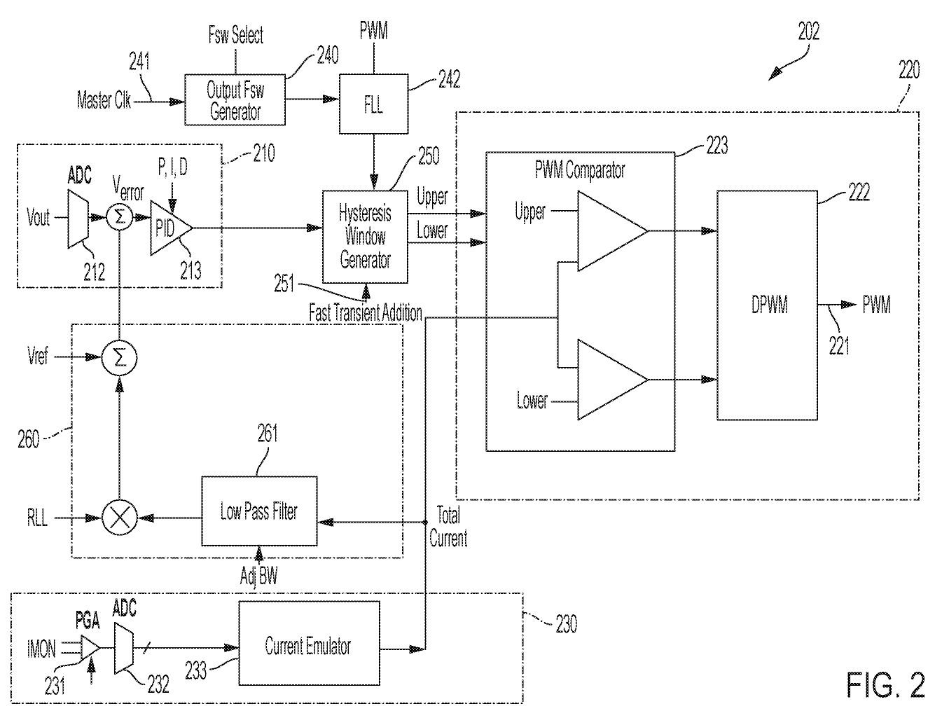

FIG. 2 depicts a control loop 202. Control loop 202 may include PID circuitry 210, pulse width circuitry 220, and current emulator block 230. Control loop 202 may include a fast transient response 251, which may facilitate a load feed forward, fast-transient response. Control loop 202 may include a dual-loop for current and voltage regulation. Current emulator block 230 may include PGA 231, ADC 232, and current emulator 233.

Control loop 202 may incorporate a master clock 241 that may orchestrate output switching frequency (FSW) generation 240. FSW generation 240 may facilitate determining the transistors' switching frequency in the power stages (i.e., phases). FSW generation 240 may be directly influenced by the FSW select input, which may initiates the FSW generation process. The generated FSW may not only drive the power transistors but may be also stabilized by the frequency locked loop (FLL) 242, which may incorporate a PWM output.

FLL 242 may monitor the actual (i.e., realized) switching frequency (e.g., PWM input) instead of or in addition to the desired switching frequency. Such operation may include providing the appropriate control loop response via hysteretic window voltage for adjustments. Moreover, FLL 242 may synchronize the oscillator's frequency, which may be derived from master clock 241 with an external reference signal, ensuring uniformity in the switching frequency throughout power switching operation. Such synchronization may be advantageous for maintaining steady performance and efficiency of the power conversion process within control loop 202. FLL output signal may be fed to hysteric window generator (HWG) 250.

HWG 250 may create a hysteretic band or window for control loop 202, where the power stage may be turned on when the current drops below a lower threshold (e.g., lower) and off when the current exceeds an upper threshold (e.g., upper). Thus, HWG 250 may establish a defined hysteretic band that may control the operational thresholds for the power stages. As utilized herein, hysteretic band may be interchangeably referred to as the hysteretic window (i.e., upper and lower voltage thresholds). When the monitored current falls beneath the lower threshold, HWG 250 may prompt a power stage (e.g., 220) to activate, thereby increasing the current. Conversely, upon detecting that the current has surpassed the upper threshold, HWG 250 may deactivate the power stage, thus reducing the current flow.

The HWG may adjust the lower and upper voltage threshold in real-time based on feedback from the output voltage. Accordingly, such dynamic hysteretic band may serve as an advantageous regulatory mechanism, operating in tandem with FLL 242 and proportional-integral-derivative (PID) controller inputs via PID circuitry 210. For example, FLL 242 may transmit a signal that may adjust the window voltage, comparing the actual switching frequency to the desired frequency, thereby performing an adjustment by the comparison. A wider window voltage may mean a lower frequency relative to a higher voltage, and a smaller voltage drives a faster frequency, relative to the lower voltage.

The PID input may allow for fine-tuned adjustments based on the hysteretic band's positioning. For example, PID output may drive the DC point of the window voltage, which may translate to the command output current. Such dual input strategy employed by HWG 250 may enable precise control over the current, contributing to controller 102’s overall objective of maintaining a robust, stable, and efficient power delivery system across multiple phases. The hysteretic band's implementation within control loop 202 may exemplify controller 102’s sophisticated design, which may be adept at handling the complexities of modern power management and distribution demands.

As shown in FIG. 2, control loop 202 may include a PID circuitry 210. PID circuitry 210, analog-to-digital converter (ADC) 211, and PID 213. PID circuitry 210 which may be configured for low latency in the feedback path, may be advantageous for real-time control systems where the response time may significantly impact system 100’s performance. For example, in power supplies for computing applications, quick adjustments to the output voltage may maintain stability. Such low latency in the feedback path may provide rapid response to changes in output voltage. ADC 212 may convert the analog voltage to a digital signal, which may be then used for telemetry and for feedback in a control loop. Telemetry data may be used to determine an adjustment to a charge deficit.

PID circuitry 210 via PID 213 may be configured for dynamic voltage error control. For example, the "voltage error" (Verror as shown in FIG. 2) may be the difference between the desired voltage set point and the actual Vout. PID 213 may process this error to adjust the control signals sent to the power stage. The "Proportional" part of PID 213 may respond to the current error, the "Integral" part may respond to the accumulation of past errors, and the "Derivative" part may respond to the rate of change of the error. By processing the error in these three ways, PID 213 may dynamically adjust the power output to quickly correct any deviations from the desired voltage, ensuring tight regulation. As utilized herein dynamic voltage error control refers to system 100’s ability to adapt to changing conditions on-the-fly. The PID algorithm of PID 213 may allow for a dynamic response by automatically adjusting the control effort based on the error and a history. Such functionality may be advantageous in power systems where load conditions may change rapidly, and the power supply may react just as quickly to prevent overshoot, undershoot, or oscillations in the output voltage. As mentioned above, PID circuitry 210 may include a feed forward fast transient response functionality that may be facilitated by fast transient response 251.

PID 213 may process a feedback signal that may be conditioned by an integrated filtering circuitry, summation circuit 260. Summation circuit 260 may advantageously tailor the feedback for optimal PID controller performance. Summation circuit 260 may include low pass filter (LPF) 261, which may serve to attenuate high-frequency noise and transients, ensuring stable PID operation by allowing low-frequency content pertinent to the control loop.

Thus, incorporating emulated current into control loop 202 may facilitate real-time adjustments to power stage operations, optimizing performance, and minimizing the risk of overcurrent or undercurrent conditions that may harm system components or the load. By strategically bypassing the noise of the power switching process, system 100 may ensure that the decision-making process is based on clean, reliable data, thereby enhancing the overall stability of the power supply system. For example, such emulated current signal may offer a facsimile of the real current flow, which PID 213 may utilize for real-time corrective actions. By utilizing such emulation approach, system 100 may maintain a high degree of control fidelity without being affected by the noise and variability of direct current measurements.

Summation circuit 260 may aid in maintaining the integrity of the feedback loop. For example, low pass filter 261 may ensure that PID 213 receives a clear and accurate representation of system 100 current state, which may be advantageous for precise power regulation. Gain adjustment, RLL, may modify the amplitude of the signal. For example such modulating may correspond to the target output setpoint, which may be based on the output current. As such, an output impedance or resistance may be supplemented (i.e., RLL).

As shown, summation Circuit (Σ) 260 may be where the various feedback signals, including the output from the low pass filters 261, may be summed with a reference voltage (Vref). Vref may serve as the target voltage level for control loop 202, and the summing circuit may combine Vref with the feedback signals to determine error between the actual and desired output. The error signal generated from this summation may be fed into the PID 213, which may adjust the power stage operation to correct the error. Thus, low pass filter 261, in conjunction and summing with Vref, may allow for tailored control across phases. Such tailored control may facilitate refined and adaptive response to both steady-state and dynamic conditions, such as load changes, which may be advantageous for high-efficiency power conversion in electronic devices.

Control loop 202 may include PWM circuitry 204. PWM circuitry 204 may include comparator and digital pulse width modulator (DPWM) 224. DPWM 224 may modulate the width of the output PWM pulses to control the power delivered to the load based on the commands from both control loops. In context of the operation of the dual loop control functionality of control loop 202, the voltage loop may maintain the output voltage by adjusting the duty cycle of the PWM signals based on the difference between the set point and the actual voltage. The current loop may ensure that the output current does not exceed a certain level, safeguarding the system against overcurrent conditions.

PID 213's inputs from low pass filter 261, may affect PWM circuitry 204, which may be responsible for modulating the PWM signals in accordance with PID 213 output. Such modulation may govern the switching behavior of the power stages within controller 102, aligning the output power delivery with system 100 real-time demands. The synergistic operation of the filtering circuitry, current emulation, PID controller, and PWM comparator may underscore the comprehensive and dynamic nature of the control strategy employed by the controller 102.

Comparator 223 may facilitate the control component that may compare the output from phase balance information with set thresholds to generate the PWM signal accurately. By adjusting, via DPWM 222, the PWM duty cycle in response to phase balance controller may ensure that individual power stages operate within designated parameters, contributing to the overall stability and performance system 100. As shown in FIG. 2 total current input to phase balance 226 may ensure that system 100 not only monitors individual phase currents but also takes into account the total current draw. Such global view may allow system 100 to make informed decisions about power allocation and phase adjustments. Thus, by connecting phases together at the output using a single control loop, control loop 202 may synchronize phases to distribute power more evenly. Control loop 202 may operate with permitted permutations of multiphase. Such permutations may include assigning any number of individual PWM outputs to a designated output (one of the four channels) facilitating a flexible configuration where control loop 202 may manage anywhere from 1 to 4 outputs with phase counts ranging from 0 to 4, with the ability to allocate these phases across the channels. Such examples provide for alternative configurations such as: a single 4 phase power supply, a dual output each with dual phases or 4 independent and separate outputs. Three phases may be used for one channel, and one phase for another, which may be useful for applications where one channel uses significantly more power than the others, herein referred to as a 3+1 configuration. In a 2+2 configuration, an even distribution of power may occur across two channels, which may be beneficial for balancing load and thermal performance. Such capability may also suggest that the controller may dynamically adjust the phase configuration based on the load or other system conditions, which may be an advanced feature demonstrating adaptability and efficiency.

HWG 250 may be further advantageous for maintaining the stability by avoiding overreaction to transient conditions. Such stability may ensure that power delivery is reliable. In high-performance power systems (e.g., 100), utilizing high-speed control loops and high-resolution DPWM 222, the precise generation and management of the hysteretic window may be advantageous for achieving the desired performance metrics. Moreover, control loop 202 may operate with “load feed forward” operation, which may operate to provide fast transient response 251.

As shown in FIG. 2 PID circuitry 210 may include, ADC 212 and PID 213. VOUTxP and VOUTxN may denote positive and negative terminals, respectively, from which the output voltage may be sensed. Such terminals may be connected across a load or a filtering component of the power supply output. ADC 312 may convert the analog signal to a digital signal. Such digital signal may represent the current output voltage level, which may be compared against the target voltage (V_Target).

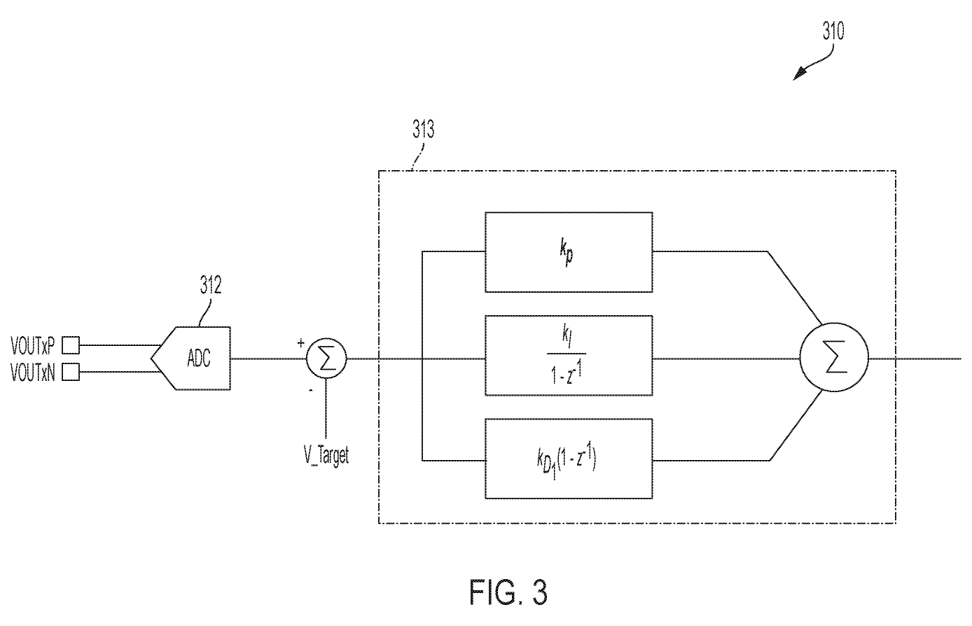

FIG. 3 a schematic 310 that depicts PID controller 313. As shown, PID controller 313 may include three elements: proportional signal (kₚ), integral signal (kᵢ/(1 - z⁻¹)), and derivative signal (k_{D}₁(1 - z^-1)). Such elements may serve as the digital implementations of the PID coefficients, with z denoting the z-transform in digital signal processing, indicative of discrete time intervals or samples. The proportional signal may amplify the difference between the target and actual voltage. The integral signal may sum this error over time, which may correct steady-state errors. And the derivative signal may predict future error based on its current rate of change.

When the voltage difference exceeds a threshold voltage, a fast transient addition may facilitate a fast transient response. With a closed loop control system for the power supply implemented with the PID compensation, the overall design may be balanced to ensure stability across the operating ranges while balancing its response to transient events. Challenges may arise in trying to speed up the response without causing excessive perturbations during steady state as the loop response is over reacting. The solution to this may be having a non-linear response where a faster response is implemented when the output voltage deviates a set window beyond the expected levels of steady state. This allows the power supply to be designed to meet the ripple specifications during steady state and improve its overall response during transients.

HWG 320 may be part of influencing the switching behavior of the power supply. HWG 250 may set two thresholds: an upper and a lower limit for a parameter, such as current or voltage. When the parameter exceeds the upper threshold, the system may react, by turning off a switch. And HWG 250 may not turn the switch back on until the parameter falls below the lower threshold. Accordingly, HWG 250 may include two states, rising and/or falling (PWM high or low).

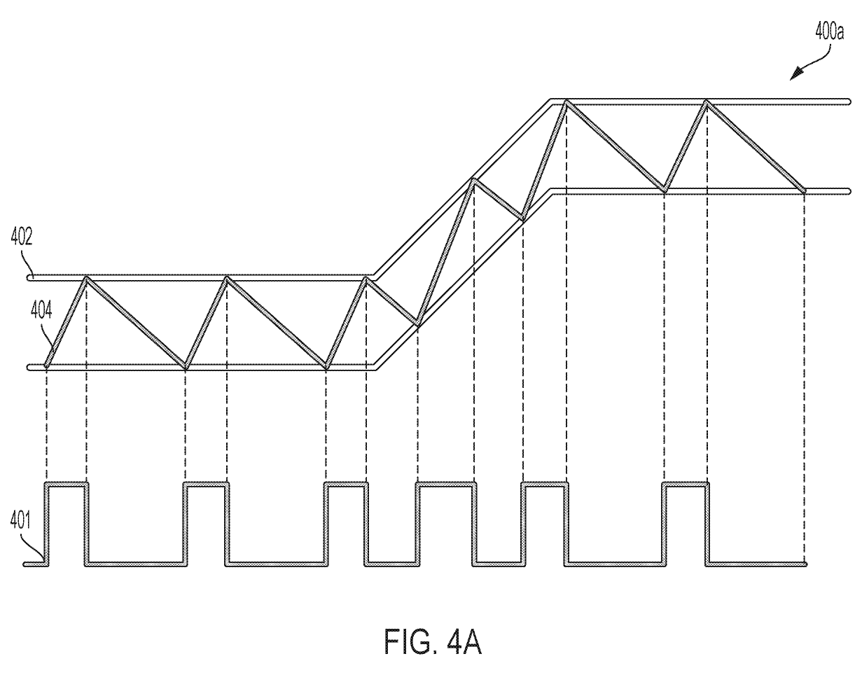

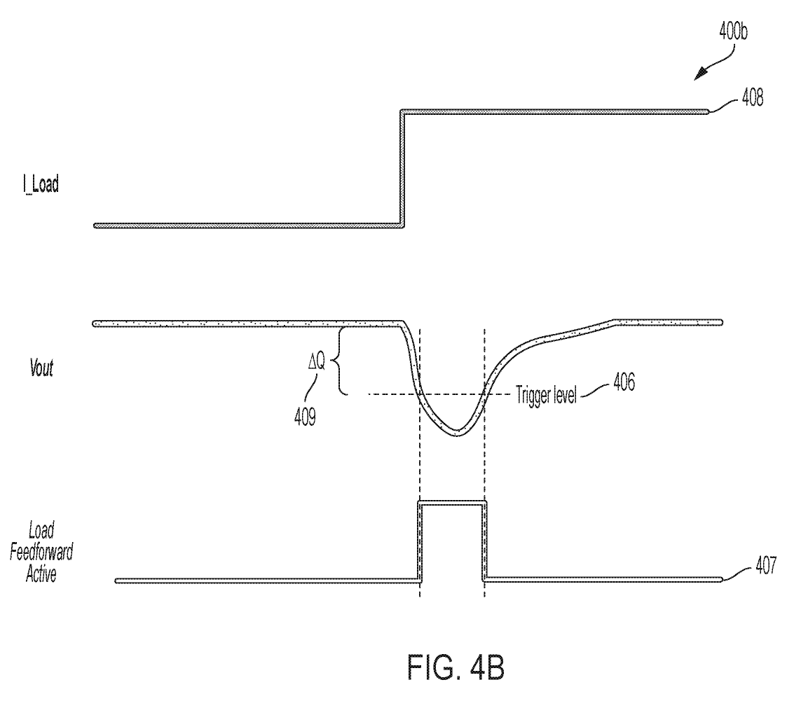

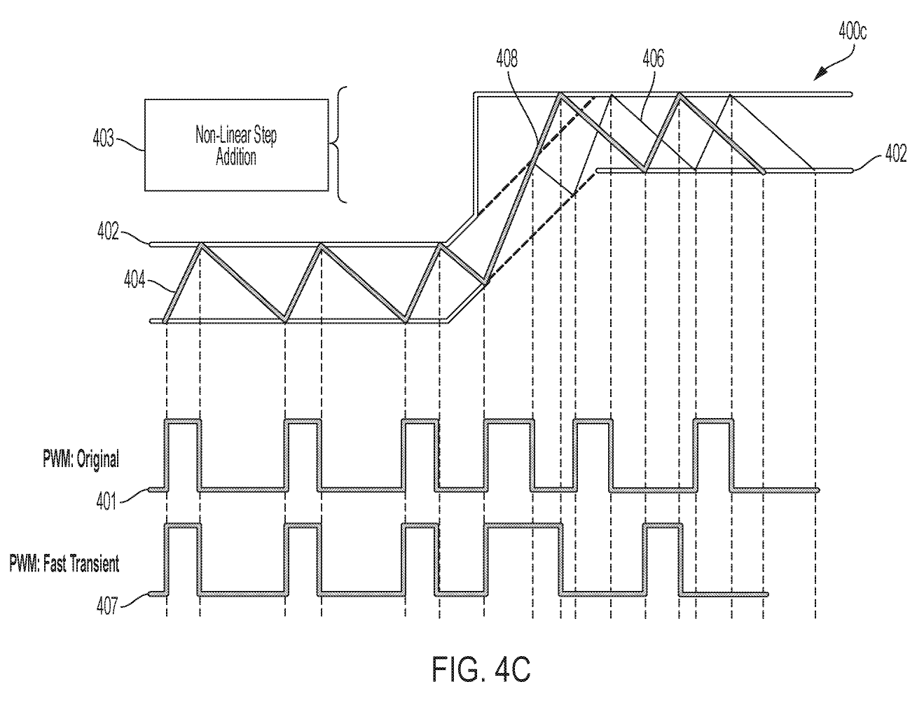

FIG. 4A depicts operation of for loop control when the fast transient response addition is disabled. FIG. 4B depicts a method for determining ΔQ and implementing the Load Feedforward Activation Pulse (LFAP) 407. FIG. 4C, depicts a fast transient response operation for when the fast transient addition is enabled.

As shown in FIG. 4A, graph 400a may depict the output voltage 404 reacting to changes in load 401 with a certain lag. Output current 402 may represent system 100’s target or desired current level based on the PID output, and inductor current which may be typically bounded by the upper and lower thresholds during steady state. A change in desired output current 402 due to a loading event on the output can be seen by the change in value of output current 402. Step changes represent a load being applied or removed. In FIG. 4B, LFAP 407 may indicate when the load feedforward mechanism may be activated in response to a transient event, such as I_Load 408. ΔQ may represent a charge deficit on the output capacitor that may occur when the load suddenly increases. System 100 supplies additional charge to maintain the output voltage (Vout), which may otherwise drop due to the increased demand.

Generally, after load application, there may be some overshoot beyond the target voltage, followed by a settling process where the voltage undershoots before stabilizing. In applications with precision, excessive settling time may be detrimental, affecting performance. Moreover, there may be a ripple observed when the load changes—a variation around the desired voltage level. Such ripple may be indicative of system 100’s feedback and control mechanisms struggling to immediately compensate for the rapid change in load, which may result in power quality issues for sensitive electronic components. Graph 400b showing output voltage Vout may indicate a notable settling time (not shown in FIG. 4A)—the time used for the output voltage to stabilize within an acceptable range after a transient. Accordingly, control loop 202, may operate to minimize these excursions to maintain the integrity of the power being supplied.

The fast transient response may respond to positive and negative transient load conditions to minimize a settling time used for the system to stabilize to the predefined voltage level. System 100 may operate with the ability to rapidly and accurately respond to such load transients via a fast-transient load feed forward response mechanism, facilitated by fast transient response 251. Such fast transient response may include non-linear control methods, as depicted by FIG. 4B. As shown in FIG. 4B, the precise adjustment may be set by a ΔQ calculation that considers the change in output current and the output capacitance (Cout). This calculation may be based on the change in Iout from the change in output voltage knowing the approximate capacitor value, which effectively positions the control voltage to a faster response location. Controller 102 may operate to recognize such significant voltage drops and actuate the non-linear step addition rapidly and accurately.

FIG. 4C, depicts the timing of loop control when system 100's fast transient response addition is not enabled. Graph 400c illustrates the output voltage’s delayed reaction to load adjustments. Such a delay showcases the lag in standard operations, where the ability of the output voltage to re-align with the target voltage level after a disturbance may offer insight into system 100’s stability and reaction speed. Depicted step changes may be indicative of a load being applied or removed, emphasizing the need for a more responsive control mechanism.

In operation, new load application may prompt an overshoot or undershoot beyond the target voltage level, followed by an oscillating settling phase where the voltage briefly drops below the target before finally achieving equilibrium. Such settling phase, if extended, may negatively affect the performance of precision-dependent systems, as stability is paramount. Control loop 202 may operate to minimize these voltage excursions to preserve the quality and reliability of the power output.

System 100’s functionality with the fast-transient load feedforward response activated may be represented in FIG. 4C. In this mode, control loop 202, may operate to promptly counteract ΔQ 409 voltage dips associated with sudden load changes. Such rapid adjustment capability may be advantageous for minimizing the depth of the voltage dip following a load change, thereby significantly reducing the time for the voltage to stabilize at its target level, thus enhancing overall system performance.

FIG. 4C further illustrates system 100’s fast-transient addition providing a singular, exact adjustment to the control voltage, which may be used for an expedited transient response. Such proactive adjustment process ensures that the response to voltage disturbances is both swift and accurate, thereby enhancing system 100’s performance during transient conditions. Load feedforward activation pulse may highlight the moment the feedforward mechanism responds to a sudden increase in load, compensating for any charge deficit to stabilize the output voltage, Vout. trigger level 406 may be set to activate this mechanism, which may be calibrated to match the specific response of system 100, ensuring that the transient response is both precise and effective.

Fast-transient response 251 may introduce a correction in response to a load change. Such corrective action may be determined by a calculated response based on system 100’s dynamic characteristics and the magnitude of the load change, ensuring Vout remains close to its desired target.

Implementing the fast-transient response strategy may notably enhance the voltage regulator's capability to manage transient conditions, ensuring that Vout remain stable. By monitoring the output and rapidly addressing abrupt changes, system 100 exemplifies a robust response, which may be characteristic of system 100 adeptness at handling dynamic loads.

System 100’s strategic approach to outpace the conventional PID control may involve adjustments to transient events to minimize the resulting voltage overshoot and undershoot. This active minimization of noise and ripple may maintain a stable operational state across a range of load conditions.

Alongside PID 213 controller, the non-linear response addition may provide an immediate reaction to detected voltage transients, offering a swifter adjustment than may be achieved through PID 213 control alone. Such rapid action mechanism operates as a voltage-controlled current source, with the hysteresis band output by HWG 250 serving as a voltage reference that may directly affect the current supplied in response to output voltage changes.

A GUI may offer an optional feature, allowing users to activate or deactivate the fast-transient response based on their system's performance. Such tunability may offer customers significant flexibility, enabling them to fine-tune the response dynamics to match the demands of their specific applications.

FIG. 4C may exhibit the fast-forward non-linear adjustment that underpins system 100’s enhanced transient response. This depiction underscores system 100’s capability to effectively handle transients and maintain output voltage stability. Thus the inclusion of the fast-transient response mechanism may markedly improve system 100’s capacity to address sudden phase changes, ensuring robust operation and voltage stability, which may be advantageous for applications where performance and reliability are of utmost importance. The fast-transient, load feedforward capability may represent a significant advancement in the design and functionality of system 100.

As further shown in FIG. 4B, the fast transient load feedforward as utilized by one or more examples herein, may include a trigger level setting, trigger level 406, which determines when the fast pulse circuit (i.e., fast transient response 251,) becomes active. Upon activation, fast transient response 251, may momentarily alter the control voltage in either direction, by adjusting upper and lower hysteretic band outputs, depending on the nature of the transient (e.g., I_Load 408). As shown in FIG. 4C, fast transient response 251, may deliver a one-time, precise repositioning adjustment via non-linear step 403, to the control voltage in response to a load transient (e.g.,I_Load 408). Such repositioning may be advantageous to achieving the desired fast transient response.

FIG. 4C depicts graph 400c, which illustrates the fast forward non-linear step addition aimed at enhancing system 100's fast transient response. Graph 400c showcases two distinct PWM operating modes, original and fast pulse. Lines 402 may demarcate the upper and lower thresholds of a hysteresis band, which may be advantageous in regulating the power stages within a power supply system. This hysteresis band may be part of a control strategy that maintains the output within a specific range by activating the power stage when the output falls below the lower threshold and deactivating it when the output exceeds the upper threshold.

Trigger level 406, which may be finer, may represent the standard pulse-width modulation (PWM) response. PWM may be a method used to maintain the voltage at a fixed reference level by varying the ratio of the signal's high to low time. Contrastingly, I_Load 408 illustrates system 100’s response when the fast transient load feedforward feature is active. Such feature may enhance system 100’s response to sudden changes in load, or transients by forcing non-linear step addition, as shown in FIG. 4C. For example, when the load changes rapidly, the PID control loop (e.g., 210), including the hysteresis band (e.g., 402) output by HWG, 250, may not react swiftly enough to compensate for the variation, potentially leading to deviations from the desired voltage level.

As shown by I_Load 408, system 100 may preemptively inject a non-linear step 403 to quickly adjust the control signal, in anticipation of the load change. Such rapid adjustment helps to position the control voltage (Vc) faster than the PID loop would without such adjustment, mitigating any voltage drop due to the transient and thus maintaining voltage stability. Thus, by predicting the amount of charge lost due to a transient event, system 100 may be capable of making informed, one-time, non-linear adjustment to the control signal to counteract the effect of the transient, thus leading to a faster return to the desired voltage level. A predictive model may be used to anticipate charge to compensate for a voltage drop due to a transient load condition.

Thus, when the fast transient response mechanism is activated, such response may bypass the slower, linear PID 213 response to provide a quicker, more responsive action to sudden load changes, as depicted by I_Load 408. The ability to implement such fast transient load feed forward response allows for a power control system that may be robust and able to maintain voltage stability even in the face of rapid load variations, which may be advantageous for high-performance applications where power integrity is paramount.

In the context of system 100, the inclusion of such fast transient response capabilities may significantly improve system 100’s ability to handle abrupt changes in load across multiple phases and/or single phase implementations of system 100. Demonstrating robust operation by quickly adjusting to maintain output voltage stability, such fast transient response may be advantageous for applications requiring high reliability and performance. The fast transient, load feed forward capability provides and advantageous aspect of system 100's design.

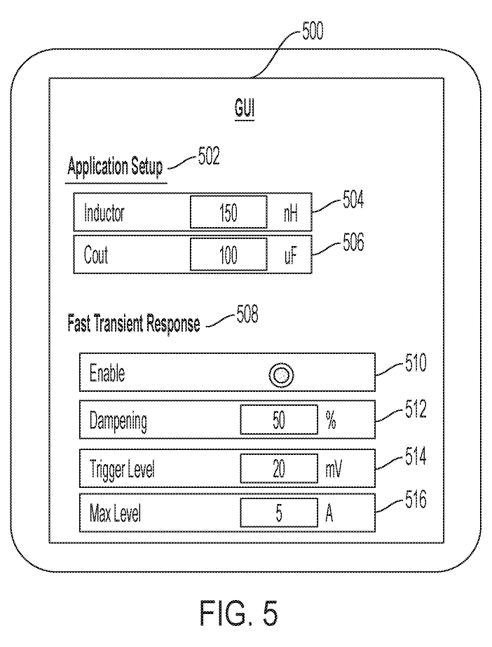

Referring now to FIG. 5, GUI 500 includes icons or buttons for facilitating an interface for setting up performance parameters of system 100. GUI 500 may include application setup 502 and fast transient response 508. Application setup 502 may include inductor setup 504 and Cout setup 506. A user may input the value of the inductor used in the power supply circuit. Inductors may influence the ripple current and the response time of the power supply. Cout setup 506 may specify the value of the output capacitance. Output capacitors may affect the voltage ripple and stability of the power supply (e.g., PWM 221).

GUI 500 may include toggle switch 510 to activate or deactivate the fast pulse response 251, allowing dynamic control based on the specific application. Dampening 512 control may adjust the amount of dampening applied to the fast pulse to prevent overshooting or ringing in system 100’s response to load transients. Dampening 512 may be represented as a percentage value indicating how much system 100’s oscillation may be reduced. Trigger level 514 may set the voltage deviation (i.e., delta Q) from the target at which the fast pulse feature may be triggered. For example, when set to 20 mV, the fast pulse may activate when the output voltage deviates by more than 20 mV from the target value.

Max level 516 may specify the maximum current (e.g., a max current setting) that the fast pulse may command. Setting a maximum level may aid in protecting system 100 from excessive current that may damage the power supply or the load. Thus, GUI 500 may be designed to allow users to tailor the power supply's performance to match the load's characteristics closely. By adjusting such settings, the user may ensure that the power supply reacts appropriately to changes in the load, maintaining a stable output voltage while avoiding undue stress on the system components.

Thus, the advanced control mechanisms integrated within system 100 may significantly enhance the responsiveness and stability of switching power supplies. The innovative incorporation of fast-transient feed forward nonlinear response capabilities addresses challenges in power management, particularly in scenarios demanding rapid transient responses. The examples described herein enable a swift and precise response to load changes, minimizing deviations from the target output and improving overall system efficiency.

The examples described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages. Furthermore, any reference to this disclosure in general or use of the word “example” in the singular is not intended to imply any limitation on the scope of the claims set forth below. Multiple examples may be set forth according to the limitations of the multiple claims issuing from this disclosure, and such claims accordingly define the example(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred examples, it is to be understood that such detail is solely for that purpose and that the disclosure is not limited to the expressly disclosed examples, but, on the contrary, is intended to cover modifications and equivalent arrangements that are within the spirit and scope of the appended claims. For example, it is to be understood that the present disclosure contemplates that, to the extent possible, one or more features of any example can be combined with one or more features of any other example.

1. A system for multiphase or single-phase power control, the system comprising:
a hysteretic window generator operable to dynamically set and modulate a lower voltage threshold and an upper voltage threshold for an individual phase within a plurality of phases based on an operating condition;
a plurality of switching power supply (SPS) stages corresponding to the plurality of phases, the plurality of SPS stages coupled to the hysteretic window generator; and
a fast transient response coupled to the hysteretic window generator, activated by a transient load condition of an output voltage change,
wherein the fast transient response outputs a non-linear step adjustment to a control voltage of the individual one of the plurality of SPS, thereby reducing a settling time and return to a predefined voltage level.

2. The system of claim 1, wherein the fast transient response is operable to provide a voltage adjustment during the transient load condition.

3. The system of claim 1, wherein the plurality of SPS stages includes an output capacitance, and the fast transient response determines the non-linear step adjustment based on the output capacitance and a change in output voltage.

4. The system of claim 1, further comprising a predictive model that anticipates charge to compensate for a voltage drop due to the transient load condition.

5. The system of claim 1, wherein the hysteretic window generator adjusts the lower and upper voltage thresholds in real-time based on feedback from the output voltage.

6. The system of claim 1, further comprising a graphical user interface (GUI) that enables a user to enable or disable fast transient addition.

7. The system of claim 6, wherein the GUI includes one or more of a dampening percentage setting, a trigger level setting, or a maximum level setting corresponding to the fast transient addition.

8. The system of claim 1, wherein the hysteretic window generator is further operable to execute phase alignment by adjusting the voltage thresholds according to phase load balancing.

9. The system of claim 1, wherein the hysteretic window generator synchronizes the activation and deactivation of the plurality of SPS stages based on adjusted voltage thresholds.

10. The system of claim 1, wherein the fast transient response is operable to respond to positive and negative transient load conditions to minimize a settling time used for the system to stabilize to the predefined voltage level.

11. The system of claim 1, wherein the system further comprises a current emulator.

12. The system of claim 1, wherein the system further comprises a voltage regulator.

13. The system of claim 1, wherein the system further comprises a summation circuit.

14. A method for optimizing transient response in a multiphase or single-phase power control system having a plurality of switching power supply (SPS) stages, the method comprising:
determining a trigger level based on one or more control settings, wherein the trigger level activates a fast transient response;
determining a charge deficit associated with a transient load condition based on an output current change and an output capacitance of the multiphase power control system; and
adjusting, based on the charge deficit, control voltage of a plurality of switching power supply (SPS) stages using a fast transient addition, thereby counteracting the transient load condition and stabilizing the multiphase or single-phase power control system output voltage.

15. The method of claim 14, further comprising adjusting the lower and upper voltage thresholds in a hysteretic window generator based on the charge deficit to enhance the multiphase power control system's transient response.

16. The method of claim 14, where the control voltage adjustment is executed through a non-linear step for reducing voltage deviation during transient load conditions.

17. The method of claim 14, further comprising:
determining an adjustment to the charge deficit, based on telemetry data; and
adjusting the trigger level based on the adjustment to the charge deficit.

18. The method of claim 14, wherein the control settings include one or more of: an inductor setting, a Cout setting, a dampening setting, a trigger level setting, or a max current setting.

19. The method of claim 14, wherein the control settings are input via a graphic user interface for the adjusting of the trigger level and charge deficit.

20. The method of claim 14, where the fast transient addition is operable to temporarily increase the control voltage in response to a sudden increase in load, thereby facilitating a faster system response.
